(19) United States
(12) Patent Application Publication
(10) Pub. No.: US 2023/0297834 A1
(43) Pub. Date: Sep. 21, 2023

(54) UTILIZING A NEURAL NETWORK FOR A PREDICTIVE REAL-ESTATE LISTING MANAGEMENT SYSTEM

(71) Applicant: Purlin Co., Torrance, CA (US)

(72) Inventor: Giorgi Chigogidze, Torrance, CA (US)

(21) Appl. No.: 17/699,632

(22) Filed: Mar. 21, 2022

(51) Int. Cl. G06N 3/08; G06Q 50/16; G06Q 30/02; G06V 10/22; G06V 10/774; G06F 16/2453

(52) U.S. Cl. CPC G06N 3/082; G06Q 50/16; G06Q 30/0201; G06V 10/235; G06V 10/774; G06F 16/24534

(57) ABSTRACT

Systems and methods for predictive real-estate listing management. Real-estate managers have many data sources available, but often lack a meaningful way to assimilate all available data. Thus, having an iterative feedback loop for culling and altering database listings of real-estate would greatly enhance one's ability to present meaningful real-estate offering to potential buyers. A system includes processing blocks for collecting a first data set of real-estate listings. Next, the method applies one or more transformations to this first data set including image data extraction; real-language data assembly, or listing data manipulation to create an enhanced data set of real-estate listings, creating a first training set comprising the collected first set of real-estate listings and the enhanced set of real-estate listings. These initial collections of data along with initial manipulations may be used to train the neural network in a first stage using the first training set.

### REFERENCE TO CO-PENDING RELATED APPLICATION

This application is related to and filed concurrently with U.S. patent application No. ______ entitled “SYSTEM AND METHOD FOR UTILIZING A NEURAL NETWORK FOR A PREDICTIVE REAL-ESTATE LISTING MANAGEMENT SYSTEM,” the entirety of which is incorporated herein by reference.

### BACKGROUND

Buying and selling real-estate involves the rapid collection, distribution, and use of highly-detailed and ever-shifting data involving intrinsic and extrinsic aspects of real-estate listings as well as public and private data about potential buyers. Within a real-estate listing there are easily ascertainable data points that are typically included (if not required) by real-estate listing services and governing bodies. For example, listings will often have details such as address, number of bedrooms, number of bathrooms, tax assessments and the like. However, other less-attainable data that may nevertheless be useful for potential buyers may include a more in-depth determination of basic facts, such as locations of bedrooms within a home, size of closets, internet access speed, community walkability factors, and the like. Such additional detail may be hard to ascertain from a simple real estate listing.

Likewise, individual buyers have individual tastes and requirement for a specific home in which interest may be shown. Typically, a buyer will also list easy-ascertainable features and amenities, such as, like before, address, number of bedrooms, number of bathrooms, tax assessments and the like. However, often times, a very specific factor tends to have greater influence over others for specific buyers that may include the less-easily attained aspects of a home listing. That is, like before, a potential buyer may begin to care less about the specific listing details of standard listing and become more interested in more in-depth determination of basic facts, such as locations of bedrooms within a home, size of closets, internet access speed, community walkability factors, and the like.

With the misaligned interests of most home listings and what potential buyers actually seek when considering a home purchase, a more robust and configurable process for matching potential buyers with proper listings is needed.

### BRIEF DESCRIPTION OF THE DRAWINGS

The subject matter presented herein will now be described, by way of example, with reference to the accompanying drawings, in which:

FIG. 1 is a block diagram of a computing environment for realizing the systems and methods of a predictive real-estate listing management system and method according to an embodiment of the subject matter disclosed herein;

FIG. 2 is a more in-depth block diagram of a modelling and prediction engine of the computing environment of FIG. 1 according to an embodiment of the subject matter disclosed herein;

FIG. 3 is a block diagram of logical block diagram of different aspects of the modelling and prediction engine of FIG. 2 presented in a manner that illustrates the iterative machine learning aspects according to an embodiment of the subject matter disclosed herein;

FIG. 4 is a hybrid block diagram and flow chart illustrating inputs, factors and weighting influences for influencing predicted outcome in a predictive real-estate listing management system of FIG. 1 according to an embodiment of the subject matter disclosed herein;

FIG. 5 is a method flowchart illustrating an exemplary computer-based method for establishing a trained neural network and updating the trained neural network to generate real-estate listing predictions according to an embodiment of the subject matter disclosed herein;

FIG. 6 is a method flowchart illustrating an exemplary computer-based method for utilizing a trained neural network and delivering matched recommendations based upon a trained neural network according to an embodiment of the subject matter disclosed herein; and

FIG. 7 is a block diagram of a generic computing device for realizing methods leading to predictive real-estate listing management systems and strategies according to one or more embodiments of the subject matter disclosed herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” as required by 35 U.S.C. § 112.

By way of an overview, systems and methods for predictive real-estate listing management are discussed. It is understood that the examples and systems discussed herein are generally applicable to any sales venture and any level of overall inventory management, however, the remainder of this discussion will focus on one example of a real-estate listing management system that involves residential listing and home buyers. As alluded to in the background, real-estate managers may have a multitude of data sets and data sources available, but often lack a meaningful or proven way to assimilate all available data and then conclusively select actions based on predictive and historical analysis of the assimilated data. For example, a real estate manager is unable to manually measure the length of time a customer has spent on photos of kitchens of various configurations and then predict the configuration that is likely to be most interesting to the customer based on the length of time the customer spent on similar kitchen photos relative to kitchens of other configurations. Thus, having a meaningful and iterative feedback loop for culling and altering database listing of real-estate would greatly enhance one's ability to present meaningful real-estate offering to potential buyers.

This may be accomplished in a first embodiment that includes an initial step for collecting a first data set of real-estate listings that are stored in a real-estate listing service database such as the Multiple Listing Service (“MLS”). Next, the method applies one or more transformations to this first data set including image data extraction; real-language data assembly, or listing data manipulation to create an enhanced data set of real-estate listings, creating a first training set comprising the collected first set of real-estate listings and the enhanced set of real-estate listings. These initial collections of data along with initial manipulations may be used to train the neural network in a first stage using the first training set. In an effort to maintain updated and improved data, the method may create a second training set for a second stage of training by culling the first training set with user-selected influences followed by continued training of the neural network in a second stage using the second training set.

In another embodiment, an initial step for collecting a first data set of real-estate listings that are stored in a real-estate listing service database initiates the novel method. Then, the method proceeds to collecting a second data set from one or more remote computer users about real-estate listing preference of the one or more remote computer users. This leads to creating a first training set comprising the collected first data set of real-estate listings and the second data set of real-estate listing preferences for training the neural network in a first stage using the first training set. As feedback in collected from one or more users, the method applies one or more transformations to the second data set including increasing or decreasing an importance factor associated with each of the about real-estate listing preferences in response to collected feedback from the one or more remoter computer users thereby creating a second training set for a second stage of training by altering the first training set with the collected remote-computer user feedback. As such, the neural network can be trained a second time (e.g., updated) in a second stage using the second training set.

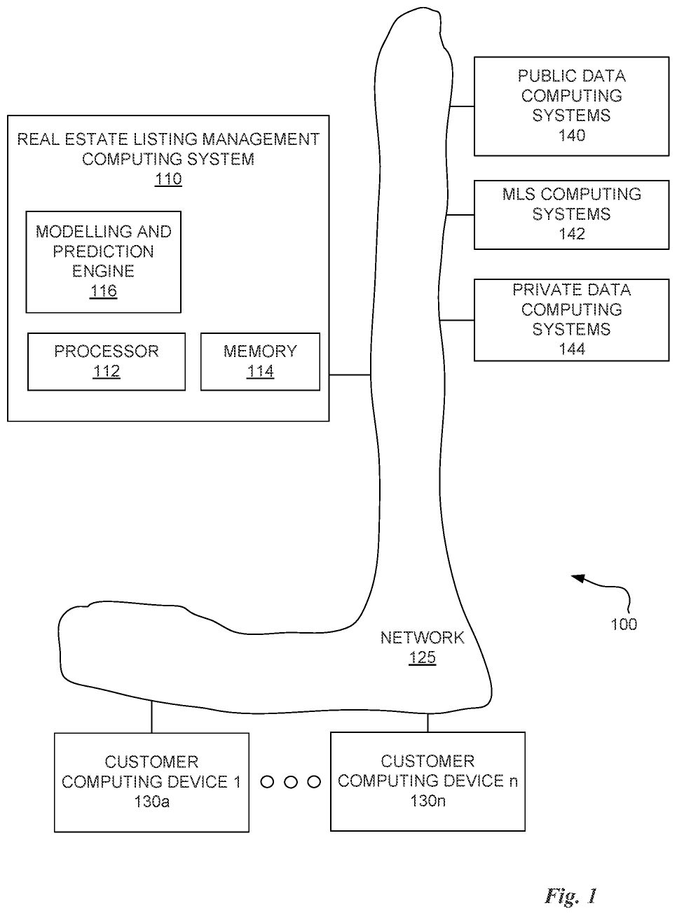

These and other aspects may be more readily understood and further detailed with respect to the detailed description below with reference to FIGS. 1-7.

Turning attention to the figures, FIG. 1 is a block diagram of a computing environment 100 for realizing the systems and methods of a predictive real-estate listing management methodology according to an embodiment of the subject matter disclosed herein. The overall computing environment 100 may be generally comprised of three sets of computing devices that are all communicatively coupled to each other through a computing network 125, such as the Internet, though the network 125 may be a local Intranet or a virtual private network or the like. The three generalized categories of the coupled computers include a real-estate listing management server computer 110, one or more customer computing-devices 130a-130n, and one or more data-service computing devices, such as public data collection devices 140, private data collection devices 144, and MLS devices 142. Other data-collection and/or data provision services (such as weather data collection services; neighborhood data collection services; crime data collection services, and the like) are contemplated but not shown in this figure here for brevity. Collectively, these computing devices may be used to receive and send data about one or more real-estate listings as well as one or more potential buyers. The real-estate listing management server computer 110, includes one or more local processors 112 that utilizes one or more memories 114 in conjunction with a real-estate listing modelling and prediction engine 116.

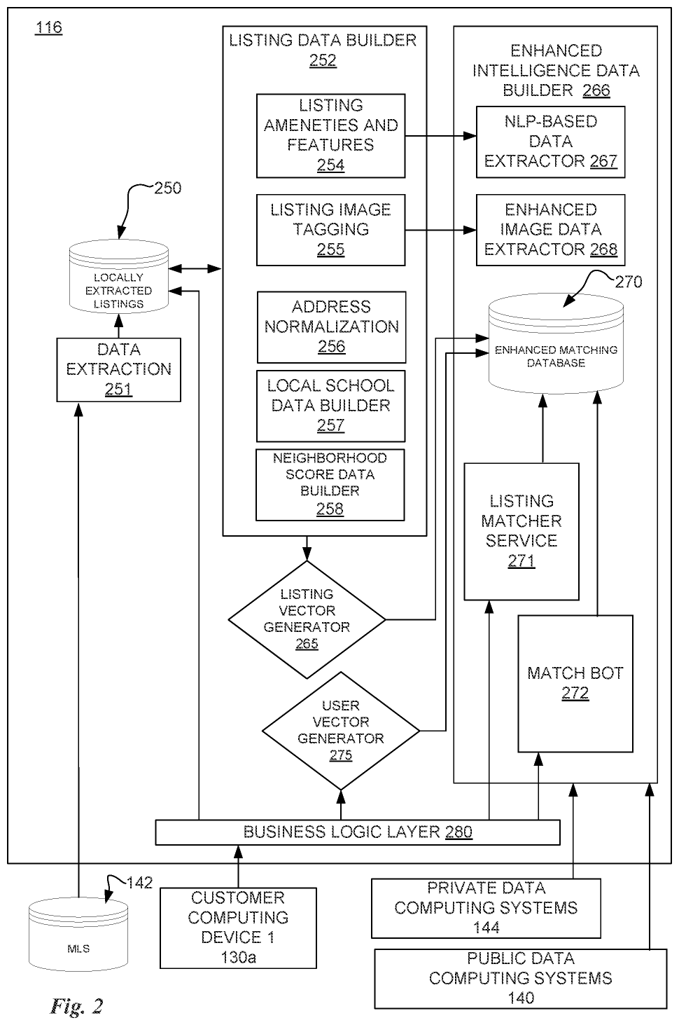

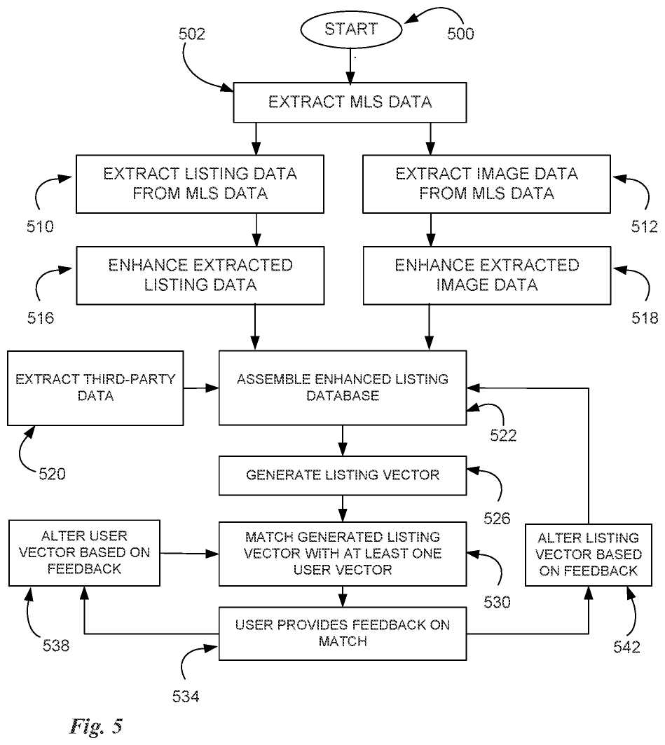

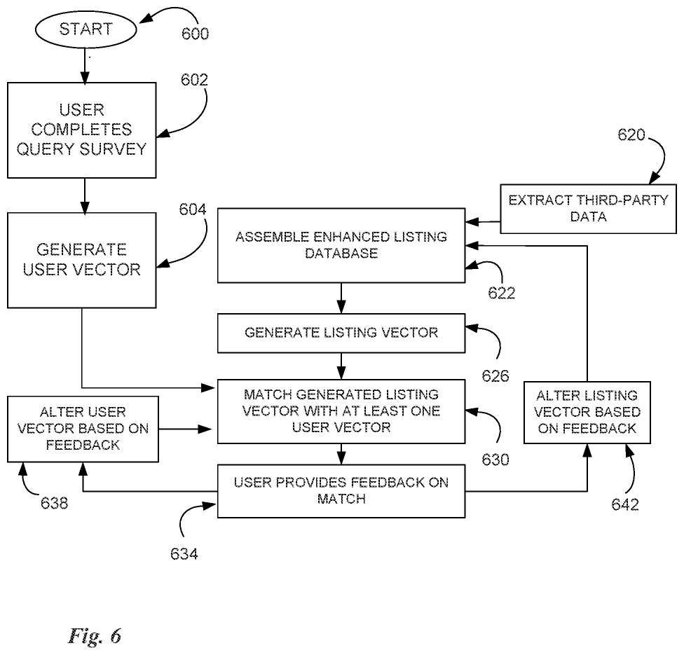

In known conventional systems, many conventionally-available real-estate listing management tools are simply maps with data where users can add their own data, but these tools do not offer additional data collection, assimilation, or analysis that would transform the pinned data into a more useful predictive function. That is, no correlative conclusions are generated and no predictive vectors are generated. For example, a predictive determination that listings having a home office may truly be a hot-market feature that goes unrealized for many months or years is a valuable machine-determinable characteristic of a market. Utilizing the overall system 100 of FIG. 1, one may take advantage of all collected data using the modelling and prediction engine 116 to predict specific amenities and features to be incorporated into practice by a real-estate listing manager for improving listings and potential buyer matching. This may be accomplished by training a prediction engine through iterative data assimilation in an algorithmic method as discussed further below with respect to FIG. 5. Further, potential buyers may also utilize the modelling and prediction engine 116 to interpret answers to questions posed through an iterative questionnaire to parse differing preferences into meaningful matches of available real estate listings. This may be accomplished by utilizing a trained prediction engine through iterative data collection to produce a more suited set of real-estate listing matches in an algorithmic method as discussed further below with respect to FIG. 6. Prior to discussing the specific algorithmic methods that can be realized using the real-estate listing management system 100 of FIG. 1, a more in-depth description of the computer blocks, functionality and components of the system is presented with respect to FIGS. 2-4.

FIG. 2 is a more in-depth block diagram of the modelling and prediction engine 116 of the computing environment of FIG. 1 according to an embodiment of the subject matter disclosed herein. As shown in FIG. 2, the modelling and prediction engine 116 is shown with numerous logical computing blocks, sub-engines, and databases. The specific nature of these components is understood by a skilled artisan to be realized in physical form in known manners such programmable gate array logic, application specific integrated circuits, neural networks, volatile memory systems and programmatic software-based or hardware-based executable instructions under the direction of one or more local or remote processors (not shown in FIG. 2). As such, the functionality of each sub system is discussed without regard to specific realization as a skilled artisan understands numerous ways to realize the novel functionality described herein. Further, for ease of illustration several components of the system 100 of FIG. 1 are shown below the modelling and prediction engine 116 for facilitating this detailed description even though these components may be remote and under management of other processors and/or organizations.

In a first area of functionality, the modelling and prediction engine 116 includes a data extraction engine 251 configured to extract real-estate listing data form third-party real-estate listing services such as MLS 142. The most common source for real-estate listing data may be the MLS 142 database, but additional databases may interface with the data extraction engine as well to assimilate real-estate listing data into a locally extracted listing database 250. Such real-estate listing data may be extracted numerous times per day as the typical MLS database will reflect daily, (if not hourly) changes as real-estate is listed, sold, put under contract, or otherwise altered often. Thus, the overall modelling and prediction engine 116 will use extracted data that is cultivated by the data extraction engine 251 often.

Once local data has been assembled in the locally extracted listing database 250 from the data extraction engine 251, modelling and prediction engine 116 may begin building an enhanced listing database 270 using several different components and/or sub engine blocks to cultivate the extracted data to be more useful in the contest of the overall real-estate listing management system 100. Thus, in a first logical block, a listing data builder 252 may begin further extraction and altering of the listing data in the locally extracted database 250. Once such extraction and altering comprises using a listing and amenities features block 254 to determine specific known amenities and features that are easily ascertained from the initial real-estate listing data. The amenities and features data may typically include basic listing facts such as number of bedrooms, number of bathrooms, number of floors, square footage, lot size, and the like. Each of the data points culled by this block 254 may correspond to typical listing data point found in any real-estate listing and within the confines of the standards settled upon by the MLS organization(s). This commonly found data may be cultivated and enhanced within the enhanced intelligence data builder 266 and is discussed further below. Similarly, a listing image tagging block 255 may also assimilate all image data found in the initial listing along with any meta data provided with said listing images. That is, any image data that is extracted from the original listing data may include identifiers, such as main bedroom, kitchen, garage, and the like. This initial image data is assembled by the listing image tagging block 255. This commonly found data may also be cultivated and enhanced within the enhanced intelligence data builder 266 and is discussed further below.

In addition to the aspects of the original listing data that may undergo enhanced data manipulation, several aspects of the original listing data may be assimilated as is without the need for any additional enhancement and/or cultivation. This data may include common address data that is assimilated into the listing data builder 252 though an address normalization block 256. Further, this data may include common school district data and school district reputation scores that is assimilated into the listing data builder 252 though a local school database builder 257. Further yet, this data may include common walk score data about neighborhood walkability scores that is also assimilated into the listing data builder 252 though a walk score data builder 258. Together, all of the afore-mentioned data that is culled and assimilated by the listing data builder 252 may be correlated into a single listing vector for use with an enhanced matching database 270 by a listing vector generator 265.

The listing vector generator 265 may be used to generate several identifiable correlations between listings (sometimes also referred to as weighting factors). The listing vector generator 265 identifies similarities among sets of real-estate listings in the listing data builder 252 and automatically groups them based on the power of those similarities. The listing vector generator maps listings in multi-dimensional vector spaces based on numerous attributions that include listing location, size of listing, number of bedrooms/bathrooms, lot area, square footage, and the like. As a result, several vectors may be generated that have commonalities, e.g., one vector may be all 3-bedroom listings, another vector may be all listings with a home office, another vector may be all listings within a specific geographic region, and the like. The vectors may be used later to match with queries generated by users through the business logic layer. These aspects are discussed further below.

In another area of functionality, the modelling and prediction engine 116 includes an enhanced intelligence data builder engine 266 configured to utilize data that has been extracted and assimilated in the enhanced data builder engine 251 as discussed above. Thus, real-estate listing data that has been assimilated into a locally extracted listing database 250 and cultivated by the data extraction engine 251 may continue building an enhanced listing database 270 using several different components and/or sub engine blocks to cultivate the extracted data to be more useful in the context of the overall real-estate listing management system 100. The extracted listing and amenities features block 254 feeds an NLP-based data extractor 267, which identifies significant data points about a given listing from various unstructured narrative descriptions of various listings created by humans and extracts such data points into structured data. Examples of such data points may include barrel vault ceilings, discrete gates, bamboo floors and the like. Similarly, a listing image tagging block 255 that assimilated all image data found in the initial listing along with any meta data provided with said listing images may feed an enhanced image data extractor 268 to cultivate additional non-traditional MLS details from the listing images. The listing image tagging block can identify the types of rooms or even multiple rooms like an open-floor concept kitchen adjoined with a living room, pendant lights, recessed lights, and the like.

In addition to the aspects of the original listing data that may undergo enhanced data manipulation, several aspects of the original listing data may be assimilated as is without the need for any additional enhancement and/or cultivation. This data may include common address data that is assimilated into the listing data builder 252 though an address normalization block 256. Further, this data may include common school district data and school district reputation scores that is assimilated into the listing data builder 252 though a local school database builder 257. Further yet, this data may include common walk score data about neighborhood walkability scores that is also assimilated into the listing data builder 252 though a walk score data builder 258. Together, all of the afore-mentioned data that is culled and assimilated by the listing data builder 252 may be correlated into a single listing vector for use with an enhanced matching database 270 by a listing vector generator 265.

Together, these functional blocks of the enhanced intelligence data builder engine 266 are used to alter and adjust data for the cultivation of the enhanced matching database 270. Additionally, the enhanced matching database 270 may be further cultivated (e.g., data is added to specific real-estate listings) by extracting data from third-party computing systems that may generally be described as being in one of two groups—public computing systems 140 (e.g., access is uncredentialed) and private computing systems 144 (e.g., access is credentialed). Data that may be extracted and added to listings in the enhanced matching database 270 may include, e.g., weather data about a listing address, crime statistics about a neighborhood, commute times to business corridors, access to high-speed internet, utility rates, tax rates, demographic data about a population, and the like. As a result, the enhanced matching database 270 includes a cultivated data set of real-estate listings that may be searchable within the context of a matching algorithm based upon unique user (potential buyer) input that utilizes machine-learned weighting factors for parsing through the enhanced listing data. The method of utilizing the enhanced matching database 270 is discussed in greater detail below with respect to FIG. 6. However, attention is now turned back to FIG. 2 whereupon potential buyer data and preferences are queried and assembled.

Byway of a non-limiting example, a prospective buyer (e.g., customer-side user of the real-estate management system 100) may interface with the system through a customer computing device 130a that is communicatively coupled to a business logic layer 280 of the modelling and prediction engine 116. The business logic layer 280 may present a user-query interface for posing interview-styled questions about real estate listing preferences. Additionally, the business logic layer 280 may discern the answers to these questions by analyzing user's behavior, actions, and interactions with the enriched listing data. For example, the amount of time that a user may spend reviewing a specific listing, or the different interactions with a specific listing may influence weighting factors collected by the business logic layer. Further, these learnings about user preferences may be focused on a room-by-room basis such that the overall preferences of a user are focused on an “inside-out” approach. That is, a user's desired listing match may be more driven by a search for rooms in a home that the user will like as opposed to a home that a user will like that happens to have matching rooms.

By interfacing with the modelling and prediction engine 116, the prospective buyer may be directly (likes and dislikes) or indirectly (through perceived actions) queried for a series of questions about real estate preferences, the answer to which may be used to generate a user vector as generated with a user vector generator 275. These questions may be more traditional questions that prospective buyers are often asked, such as price range, geographic locations, number of bedrooms, and other similar traditional house-hunting questions. Additionally, the novel modelling and prediction engine 116 may also query for non-traditional preferences aimed to cultivate a more useful user vector when looking to generate matches from enhanced listings. The following paragraphs discuss the myriad questions that may be used to initiate an iterative process to cultivate a user vector as the user is matched with listings and then offers further feedback (e.g., like or dislike) that creates a feedback loop for a machine-learning algorithm to continuously improve the user vector.

The user vector generator 275 may be influenced by several user-directed weighting factors which may be associated with one or more answers to queries provided by the user or by one or more actions the user took relative to a listing, a photo, or some other data component of the enhanced listing data. A first example of a weighting factor may be a user preference for a specific kind of room offered by a listing, such as a home office, or a gourmet kitchen. Another example may be geographic location desired or school district desired. Another example may be proximity to parks and recreation or public transport; Another example, may be walkability score of a neighborhood. Another example may be generalized concepts such as high ceilings or open-floor plan.

As a user continues to cultivate answers to real estate listing questions, the user may further interface with the enhanced matching database 270. In a first interactive manner, the user may direct the use listing matching service 271 that may offer an opportunity to identify an initial list of matching listings based on an initial user vector that was generated based on initial queries. The user may then iteratively provide feedback for each initial matched listing that further influences both the user vector as well as the listing vector using a machine-learning feedback loop. Thus, if a user is to repeat the request for matching listings using the listing matcher service 271, the returned initial list may now be different because of the influence of the feedback on both the user vector and various listing vectors.

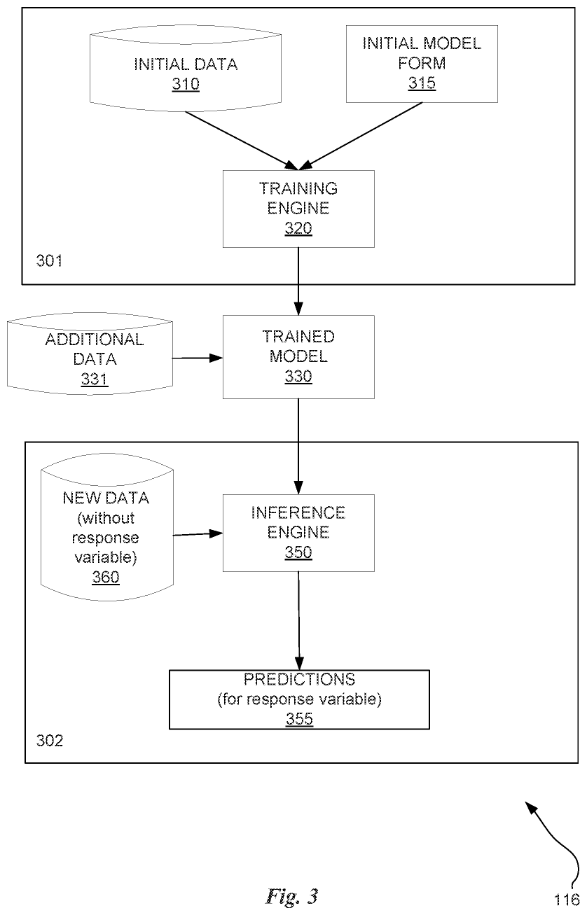

Similarly, this iterative process may be executed by a match bot 272 that initiates and delivers a list of potentially interesting listing based on a current iteration of the user vector. Such listing may be communicated to the user (via email or the like) whereupon a user may review the selections offline and return feedback in non-real time. The feedback though the match bot 272 also influences, in an iterative manner, the user vector as well as the initially selected listing vectors. Collectively, user vectors and listing vectors are continuously and iteratively updated by user behavior in an iterative, machine-learning manner. To this end, disliked listing may be pulled from the available listing for matchings all while specific listing details can be used to further train the neural network with iterative sets of useful feedback. The specific nature of a neural network is discussed next with respect to FIG. 3 and its subsequent training methodology below with respect to FIG. 5.

FIG. 3 is a block diagram 300 of logical block diagram of different aspects of the modelling and prediction engine 116 of FIG. 2 presented in a manner that illustrates the iterative machine learning aspects according to an embodiment of the subject matter disclosed herein. In this block diagram 300, some modules may represent functional activities, such as data collection and training, but this diagram is nevertheless, presented in a block diagram format to convey the functional aspects of the overall modelling and prediction computing block 116. Thus, in FIG. 3, a first aggregated set of functions includes the upper half 301 of the diagram where a predictive model is first established and trained for use in making predictions. Once the trained model 330 is established, the lower half 302 of the block diagram of FIG. 3 focuses on generating initial predictions to be checked against expected or historical data as well as new predictions based on new data collected. Collectively, the interrelated functional blocks of FIG. 3 may be commonly referred to as a neural network.

In the upper half 301, initial data 310 (e.g., locally extracted listings 250 of FIG. 2) may be drawn from an established database (e.g., MLS 142 of FIG. 2) of real-estate listing management input data along with an initialized model form 315 (e.g., listing data builder 252 of FIG. 2) to a training engine 320 (enhanced intelligence data builder 266 of FIG. 2). The initial data may include actual collected data from historical records of a local area, of a region, or globally. Further, the initial data may be created based on learned judgment of best management practices. Further, the initial model form may be pre-established using best modeling practices such that the model form includes known influences for, for instance, highly sought-after listing amenities (e.g., home office, proximity to public transport, school district data, and the like). This initial model form is simply an initial “best guess” by administrators of the predictive real-estate listing management system. As the initial data 310 may also include outcomes and other measurable performance data, a training engine 320 may begin to “train” the model form 315 by identifying specific data correlations and data trends that affect the measurable outcomes from the initial data 315. For example, a correlation may be drawn between optimal appeal (a prediction) and open floor plan design (an input). As all relevant and/or influential correlations are determined by the training engine 320, a trained model 330 (e.g., enhanced matching database 270 of FIG. 2) is established.

With the trained model 330 established, an inference engine 350 (e.g., listing matcher service 271 or match bot 272 of FIG. 2) may then utilize the trained model 330 along with newly collected input data from user queries. Thus, a user may wish to use the system to predict optimal matching to potential real-estate listing based on answers to questions posed to the user. The user may present new data 360 in the form of answers to the queries and feedback about matched listings. The new data 360 is used by the inference engine 350 that employs use of the trained model 330 to generate one or more predictions 355 (e.g., new matches for the user, influencing the listing vector or the user vector, and the like). As matched listings are reviewed by the user, additional data may be generated based on a like or a dislike of the matched listing. This additional data 331 may then be used in an iterative manner to further influence the trained model by assimilating relative feedback across several possible weighting factors (e.g., the listing attributes corresponding to disliked listings).

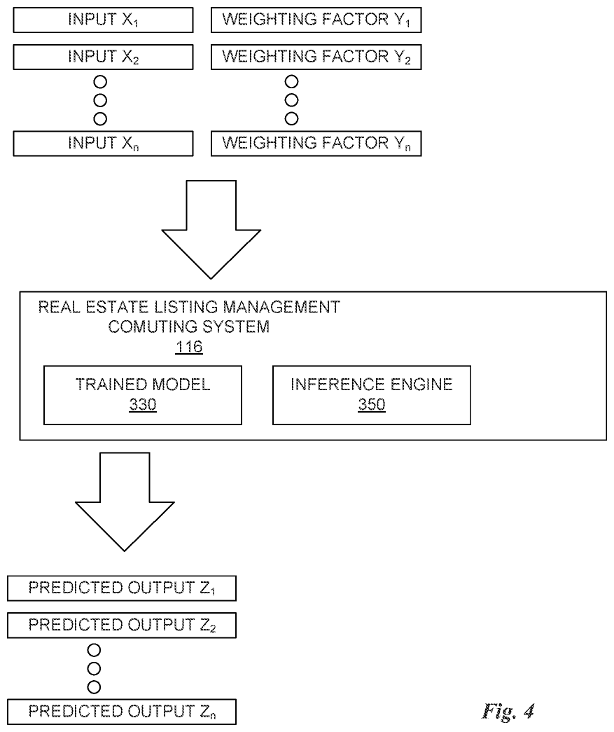

FIG. 4 is a hybrid block diagram and flow chart illustrating inputs, factors, and weighting influences for generating a predicted outcome in a predictive real-estate listing management system of FIG. 1 according to an embodiment of the subject matter disclosed herein. As discussed above, all user vectors and listing vectors may be influenced (e.g., associate data underlying said user/listings vectors are changed) based upon iterative feedback within the system (e.g., machine learning). In general, all inputs that may be used to determine one or more outcomes or predictions are illustrated in a top portion of FIG. 4, while all outcomes and predictions are illustrated in a bottom portion of FIG. 4. FIG. 4 illustrates one or more algorithms that may be realized during the establishment of the trained model 230 whereby the real-estate listing management server 116 may establish specific predictions Z₁-Zₙ based on new data through its inference engine 350. That is, given inputs X₁-Xₙ, each with corresponding weighting factors Y₁-Yₙ, (that may have changing values based on the iterative influence of activity) the inference engine 350 will utilize the trained model 330 to generate predicted outputs Z₁-Zₙ. Generally speaking, the weighting factors Y₁-Yₙ may be a result of the prediction process whereby different weighting factors are determined to be more or less influential over the prediction processes. For example, initial weighting factors may be zero as there does not exist any predictive data yet—but as predictions emerge and comparisons to reality are determined, weightings of influential factors may also emerge. These concepts may be better understood with respect to the following non-limiting examples.

In a first example prediction attainable from by the trained model 330, one may predict listing values based on desired and/or sought-after amenities. In another example prediction supported by the trained model 330, one may predict the best updates or upgrades for a specific listing that would most improve the chances of sales success. Still further example predictions include predictions of a given user's taste and preferences based on their interactions with a set of listings and comparing it to how others with similar interactions reacted to various options, amenities, room layouts and the like. Such predictions may provide insight into the next hot markets or markets that may be cooling.

FIG. 5 is a method flow chart illustrating an exemplary computer-based method for establishing a trained neural network and updating the trained neural network to generate real-estate listing predictions according to an embodiment of the subject matter disclosed herein. As is illustrated in the flow chart of FIG. 5 via several different branches and action blocks, an exemplary method may include collecting a first data set of real-estate listings that are stored in a real-estate listing service database, applying one or more transformations to the first data set including image data extraction; real-language data assembly, or listing data manipulation to create a enhanced data set of real-estate listings, creating a first training set comprising the collected first set of real-estate listings and the enhanced set of real-estate listings; training the neural network in a first stage using the first training set; creating a second training set for a second stage of training by culling the first training set with user-selected influences; and training the neural network in a second stage using the second training set.

The method may begin at step 500 and proceed to extracting MLS data at step 502. As mentioned previously, data extraction from an MLS database may include the entirety of a real-estate listing so that the MLS record is also stored at a local database with respect to the real-estate listing management system of FIG. 1. With a locally extracted MLS listing now store locally, the method may proceed to concurrent branches to pull enhanced data from the listing according to the novel methods disclosed herein. Thus, at step 510 specific listing data is delineated (as delineated from image data) so as to be analyzed at step 516 for enhanced listing data extraction. That is, the method applies one or more transformations to the listing data that includes real-language data assembly or listing data manipulation. These data transformations take the listing data from the MLS database (e.g., from the locally stored copy) and change the data into more suitable formats for use by the subsequent decision engines and matching bots. Likewise, at step 512 specific image data is delineated (as delineated from listing data) so as to be analyzed at step 518 for enhanced image data extraction. That is, the method applies one or more transformations to the image data that includes real-language data assembly or image data manipulation. These data transformations take the image data from the MLS database (e.g., from the locally stored copy) and change the image data into more suitable formats for use by the subsequent decision engines and matching bots. Lastly, third-party data may also be extracted from a third-party server at step 520 so as to assemble an enhanced listing database (step 522) that now includes all original data transformed into suitable formats for use in generating listing vectors and user vectors.

The differing kinds of data to be stored in the enhanced listing database may include walkability data about real estate listing neighborhoods, school district data about real estate listing neighborhood, crime statistic data corresponding to a neighborhood about a real estate listing, individual room data (e.g., names, configurations, styles, amenities). Additionally, extractions may be directed to real-language extractions such as so-called buzzwords like “view”, “prestigious,” “private,” “kid-friendly,” “retirement,” and the like. Further, extractions may be directed to image data extractions such as determinations about a style of the images, e.g., country, modern, mission, craftsman, Victorian, and the like. A skilled artisan understands that these enhanced listing database extraction may also include aspects directed to listing features and listing amenities.

With an assembled enhanced listing database, the method may then generate one or more listing vectors based on the data in the enhanced listing database at step 526. At step 530 then, the initial listing vector generated at step 526 (first time through) may be subject to initial listing vector matching rules that are assembled according to best known practices prior to any feedback from any user. Thus, initial vector matching factors may include basic attributes such as geographic location and price point, but may not include nuanced specifics unique to a user such as desire for a study/reading room or main floor bedroom, for example. A user may then be presented with one or more listing vector matches subject to an opportunity to provide feedback about the match at step 534. Further, in other embodiments, random matches may be provided initially as a way of gaining feedback that will be used to influence follow-on matches. That is, the user may indicate that a match is desirable or undesirable and may be able to indicate reasons why it is desirable or undesirable. Based on this feedback, the enhanced listing database may be culled, altered, or otherwise changed as a specific use my find a listing to be undesirables because of location, lack of features, lack or amenities, improper neighborhood data or any other factor.

Based on the feedback, two different feedback loops are initiated. In a first feedback path 542, the listing vector may be updated, changed, or otherwise transformed based on the feedback and then subsequently fed back into the enhanced listing database at step 522 (e.g., creating a second training set for a second stage of training by culling the first training set with user-selected influences; and training the neural network in a second stage using the second training set). Similarly, in a second feedback path 538, the user vector may be updated, changed, or otherwise transformed based on the feedback and then subsequently fed back into the matching step 530 (e.g., repeating the match process with newly updated enhanced listing data as well as altered selection rules for this user). These feedback loops may continue in perpetuity.

Further, additional information can be drawn from the enhanced listing database at listings tend to exhibit matching (with each other) characteristics which leads to a clustering of listings having similar desirable features and amenities. With this iterative training process in place, clusters of listings may be identified by both desirable and undesirable feedback to find clusters of similar listing. Such clusters may then be targeted to subsequent users based on learned predictive behavior for each next user relative to a cluster. That is, once an initial user or any subsequent user establishes a pattern of likes and dislikes, cluster of listings may open up to suggestion or targeting based on the learned behavior of the neural network and the decision engine.

FIG. 6 is a method flow chart illustrating an exemplary computer-based method for utilizing a trained neural network and delivering matched recommendations based upon a trained neural network according to an embodiment of the subject matter disclosed herein. As is illustrated in the flow chart of FIG. 6 via several different branches and action blocks, an exemplary method may include collecting a first data set of real-estate listings that are stored in a real-estate listing service database; collecting a second data set from one or more remote computer users about real-estate listing preference of the one or more remote computer users; creating a first training set comprising the collected first data set of real-estate listings and the second data set of real-estate listing preferences; training the neural network in a first stage using the first training set; applying one or more transformations to the second data set including increasing or decreasing an importance factor associated with each of the real-estate listing preferences in response to collected feedback from the one or more remote computer users; creating a second training set for a second stage of training by altering the first training set with the collected remote-computer user feedback; and training the neural network in a second stage using the second training set.

The method may begin at start step 600 and proceed to collecting remote-computer user preference data about real-estate listings at step 602. This collection may be in the form of an iterative survey presenting a series of questions to the remote user in an electronic format. This Q & A format may include specific questions about a user's real-estate preference such as relative importance of factors like, walkability statistics, school district statistics, crime statistics, room preferences, style preferences and the like. Based upon answers to these questions, a user may have a user vector generated at step 604 that can be used in matching algorithms for identifying possible real-estate listing in which the user may be interested. With this collected preference data, a neural network that includes an enhanced real-estate listing database (as discussed above with respect to FIG. 5) may be engaged, utilized, and updated based on user feedback and interactions.

At first pass, the assembled enhanced listing database (represented as step 622, but typically accomplished previously as discussed with respect to FIG. 5) is accessed to generate one or more listing vector at step 626. At step 630 then, the initial listing vector generated at step 626 (first time through) may be subject to initial listing vector matching rules that are assembled according to best known practices prior to any feedback from any user. Thus, initial vector matching factors may include basic attributes such as geographic location and price point, but may not include nuanced specifics unique to a user such as desire for a study/reading room or main floor bedroom, for example. A user may then be presented with one or more listing vector matches subject to an opportunity to provide feedback about the match at step 634. That is, the user may indicate that a match is desirable or undesirable and may be able to indicate reasons why it is desirable or undesirable. Based on this feedback, the enhanced listing database may be culled, altered, or otherwise changed as a specific user may find a listing to be undesirables because of location, lack of features, lack or amenities, undesirable neighborhood data or any other factor.

Based on the feedback, two different feedback loops are initiated. In a first feedback path 642, the listing vector may be updated, changed, or otherwise transformed based on the feedback and then subsequently fed back into the enhanced listing database at step 5622 (e.g., creating a second training set for a second stage of training by culling the first training set with user-selected influences; and training the neural network in a second stage using the second training set). Similarly, in a second feedback path 638, the user vector may be updated, changed, or otherwise transformed based on the feedback and then subsequently fed back into the matching step 630 (e.g., applying one or more transformations to the second data set including increasing or decreasing an importance factor associated with each of the about real-estate listing preferences in response to collected feedback from the one or more remoter computer users; creating a second training set for a second stage of training by altering the first training set with the collected remote-computer user feedback). These feedback loops may continue in perpetuity.

Further, additional information can be drawn from the enhanced listing database as listings tend to exhibit matching (with each other) characteristics which leads to a clustering of listings having similar desirable features and amenities. With this iterative training process in place, clusters of listings may be identified by both desirable and undesirable feedback to find clusters of similar listing. Such clusters may then be targeted to subsequent users based on learned predictive behavior for each next user relative to a cluster. That is, once an initial user or any subsequent user establishes a pattern of likes and dislikes, cluster of listings may open up to suggestion or targeting based on the learned behavior of the neural network and the decision engine.

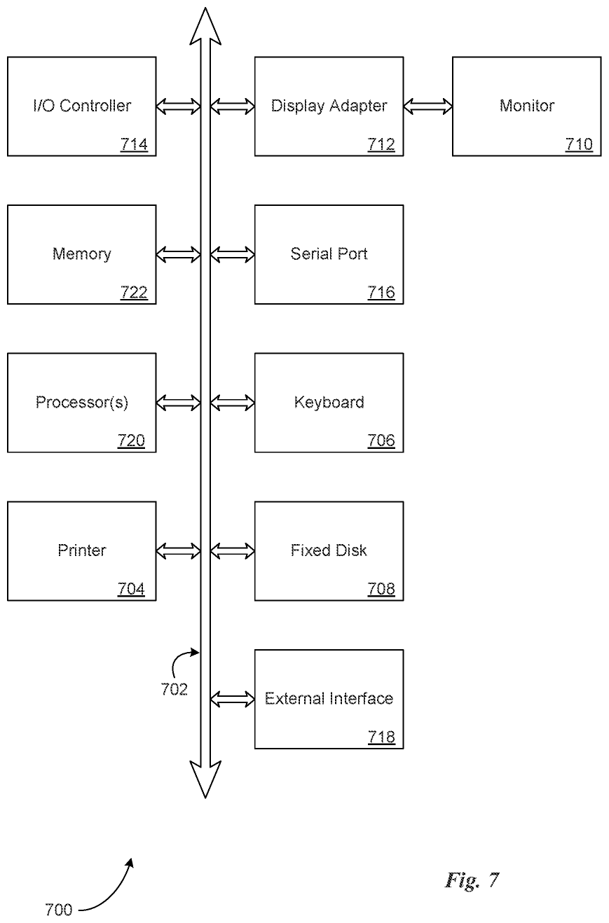

FIG. 7 and the following discussion are intended to provide a brief, general description of a suitable computing environment in which the subject matter disclosed herein may be implemented. Although not required, aspects of the subject matter disclosed herein will be described in the general context of computer-executable instructions, such as program modules, being executed by a personal computer. Generally, program modules include routines, programs, objects, components, data structures, and the like, that perform particular tasks or implement particular abstract data types. Such program module may be embodied in both a transitory and/or a non-transitory computer-readable medium having computer-executable instructions. Moreover, those skilled in the art will appreciate that the invention may be practiced with other computer system configurations, including hand-held devices, cellular or mobile telephones, multiprocessor systems, microprocessor-based or programmable consumer electronics, network PCs, minicomputers, mainframe computers, and the like. The invention may also be practiced in distributed computing environments where tasks are performed by remote processing devices that may be linked through a communications network. In a distributed computing environment, program modules may be located in both local and remote memory storage devices.

FIG. 7 is a diagram illustrating elements or components that may be present in a computer device or system 700 configured to implement a method, process, function, or operation in accordance with an embodiment of the information disclosed herein. It may include the system, apparatus, methods, processes, functions, and/or operations for enabling efficient configuration and presentation of a user interface to a user, based on the user's previous behavior, and may be wholly or partially implemented in the form of a set of instructions executed by one or more programmed computer processors, such as a central processing unit (CPU), graphics processing unit (GPU), or microprocessor. Such processors may be incorporated in an apparatus, server, client or other computing or data processing device operated by, or in communication with, other components of the system. FIG. 7 illustrates elements or components that may be present in a computer device or system 700 configured to implement a method, process, function, or operation in accordance with an embodiment. The subsystems shown in FIG. 7 are interconnected via a system bus 702. Additional subsystems include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to additional devices and/or systems not shown in FIG. 7, including a wide area network (such as the Internet), a mouse input device, and/or a scanner. The interconnection via the system bus 702 allows one or more processors 720 to: communicate with each subsystem, control the execution of instructions that may be stored in a system memory 722 and/or the fixed disk 708, and to exchange information between subsystems. The system memory 722 and/or the fixed disk 708 may represent any tangible computer-readable medium.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer-readable medium having stored thereon computer executable instructions that when executed by the processor of a computer control the computer to perform steps. Exemplary computer-readable media suitable for implementing the subject matter described herein include non-transitory computer-readable media, such as disk memory devices, chip memory devices, programmable logic devices, and application-specific integrated circuits. In addition, a computer-readable medium that implements the subject matter described herein may be located on a single device or computing platform or may be distributed across multiple devices or computing platforms.

The system may use a bus 702 that can be any of several types of suitable bus structure(s) including the memory bus or memory controller, a peripheral bus or external bus, and/or a local bus using any suitable variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The systems and methods herein enable rapid ingestion of big data sets in a distributed computing environment. The metadata-driven approach intake processing reduces source ingestion time, enhances reliability, and automates data intake. Furthermore, the platform agnostic nature of the present disclosure can operate on an input source in any electronic format. The error logging and reporting of the present disclosure further enable users to monitor progress and identify bad data based on predetermined or dynamically generated validation tolerances.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Any communication, transmission and/or channel discussed herein may include any system or method for delivering content (e.g., data, information, metadata, and the like), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, and the like), an “eBook,” an “emagazine,” an application or microapplication (as described herein), an SMS or other type of text message, an email, Facebook, Twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000@, WINDOWS®XP®, WINDOWS®Vista®, WINDOWS® 7@, OS2, UNIX®, LINUX®, SOLARIS®, MacOS, and the like) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc., which is read by and written to by the removable storage drive. As will be appreciated, the removable storage unit includes a computer-usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet account), a communications port, a Personal Computer Memory Account International Association (PCMCIA) slot and account, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular 30 link, a radio frequency (RF) link, wireless and other communications channels.

The terms “computer program medium” and “computer-usable medium” and “computer-readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware may include components such as application-specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks. Additionally, aspects of system described herein may utilize frameworks and technologies such as NET Core, Xamarin, WPF/XAML, ADO.NET, Entity Framework, React, Next, FLASK, MS SQL, Mongo DB, Azure, AWS.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix, MySQL, Interbase, and the like, may be used to provide an Active Data Object (ADO) compliant database management system. In one embodiment, the Apache web server is used in conjunction with a Linux operating system, a MySQL database, and the Per, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®, JAVASCRIPT, active server pages (ASP) common gateway interface scripts (CGI), extensible markup language (XML), dynamic HTML, cascading style sheets (CSS), AJAX (Asynchronous JAVASCRIPT and XML), helper applications, plug-ins, and the like. A server may include a web service that receives a request from a web server, the request including a URL and an IP address (123.56.555.234). The web server retrieves the appropriate web pages and sends the data or applications for the web pages to the IP address. Web services are applications that are capable of interacting with other applications over a communication means, such as the internet. Web services are typically based on standards or protocols such as XML, SOAP, AJAX, WSDL and UDDI. Web services methods are well known in the art and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on an Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, maps, color-coded data sets, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as R, C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an Internet-based embodiment, an entirely hardware embodiment, or an embodiment combining aspects of the Internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method are described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special-purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special-purpose hardware-based computer systems which perform the specified functions or steps, or suitable combinations of special-purpose hardware and computer instructions. Further, illustrations of process flow and the descriptions thereof may make reference to use WINDOWS®, webpages, websites, web forms, prompts, and the like. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity. Further yet, all aspects of any computer system mentioned heretofore may utilize known Machine Learning and AI Technologies such as Tensorflow, Keras, (CNN, RNN), SpaCy, NeuroNER, NER, FastText, Scikit-leam, OpenCV, XGBoost, LightGBM, Pandas, Scipy, Numpy, Matplotlib, Seabom, RAS.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location.

Systems, methods and computer program products are provided. In the detailed description herein, references to “various embodiments”, “one embodiment”, “an embodiment”, “an example embodiment”, and the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

Since many modifications, variations, and changes in detail can be made to the described preferred embodiments of the subject matter, it is intended that all matters in the foregoing description and shown in the accompanying drawings be interpreted as illustrative and not in a limiting sense. Thus, the scope of the subject matter should be determined by the appended claims and their legal equivalence.

What is claimed is:

1. A computer-implemented method for training a neural network for real-estate listing management comprising:
collecting a first data set of real-estate listings that are stored in a real-estate listing service database;
applying one or more transformations to the first data set including image data extraction; real-language data assembly, or listing data manipulation to create an enhanced data set of real-estate listings;
creating a first training set comprising the collected first set of real-estate listings and the enhanced set of real-estate listings;
training the neural network in a first stage using the first training set;
creating a second training set for a second stage of training by culling the first training set with user-selected influences; and
training the neural network in a second stage using the second training set.

2. The computer-implemented method of claim 1, wherein collecting the first data set of real-estate listings comprises collecting walkability data about real estate listings.

3. The computer-implemented method of claim 1, wherein collecting the first data set of real-estate listings comprises collecting school district data about real estate listings.

4. The computer-implemented method of claim 1, wherein collecting the first data set of real-estate listings comprises collecting crime statistic data corresponding to a neighborhood about real estate listings.

5. The computer-implemented method of claim 1, wherein collecting the first data set of real-estate listings comprises collecting individual room data about real estate listings.

6. The computer-implemented method of claim 1, wherein collecting the first data set of real-estate listings comprises collecting style data about real estate listings.

7. The computer-implemented method of claim 1, wherein collecting the first data set of real-estate listings comprises:
extracting data from description data associated with real-estate listings; and
generating discrete digital data based upon the extracted descriptive data.

8. The computer-implemented method of claim 1, wherein collecting the first data set of real-estate listings comprises:
extracting data from image data associated with real-estate listings; and
generating discrete digital data based upon the extracted image data.

9. The computer-implemented method of claim 1, wherein collecting the first data set of real-estate listings comprises:
extracting data from amenity data associated with real-estate listings; and
generating discrete digital data based upon the extracted amenity data.

10. The computer-implemented method of claim 1, wherein collecting the first data set of real-estate listings comprises:
extracting data from features data associated with real-estate listings; and
generating discrete digital data based upon the extracted features data.

11. The computer-implemented method of claim 1, wherein culling the first data set of real-estate listings comprises excluding real-estate listings from the first data set identified as undesirable to the user.

12. The computer-implemented method of claim 1, wherein culling the first data set of real-estate listings comprises excluding real-estate listings from the first data set identified as lacking an amenity.

13. The computer-implemented method of claim 1, wherein culling the first data set of real-estate listings comprises excluding real-estate listings from the first data set identified as lacking a feature.

14. The computer-implemented method of claim 1, wherein culling the first data set of real-estate listings comprises adding new real-estate listings from the first data set identified as being desirable to the user.

15. A computer system for training a neural network for real-estate listing management, comprising:
a real-estate listing database coupled to a network;
a real-estate listing management computing device coupled to the network and configured to:
collect a first data set of real-estate listings from the real-estate listing database;
apply one or more transformations to the first data set including image data extraction; real-language data assembly, or listing data manipulation to create an enhanced data set of real-estate listings;
create a first training set comprising the collected first set of real-estate listings and the enhanced set of real-estate listings;
train the neural network in a first stage using the first training set;
create a second training set for a second stage of training by culling the first training set with user-selected influences; and
train the neural network in a second stage using the second training set.

16. The computer system of claim 15, further comprising a user-based computing device coupled to the network and configured to facilitate user input to cull the first training set.

17. The computer system of claim 15, further comprising a remote computing device coupled to the network and configured to provide crime statistic data used for transforming the first data set.

18. The computer system of claim 15, further comprising a remote computing device coupled to the network and configured to provide walkability data used for transforming the first data set.

19. The computer system of claim 15, further comprising a remote computing device coupled to the network and configured to provide school district data used for transforming the first data set.

20. The computer system of claim 15, further comprising a remote computing device coupled to the network and configured to provide weather data used for transforming the first data set.
